(19) United States
(12) Patent Application Publication
(10) Pub. No.: US 2014/0003903 A1
(43) Pub. Date: Jan. 2, 2014

(54) PACKAGE STACKING APPARATUS

(71) Applicants: ZHAO-YONG LI, Shenzhen City (CN); LIAN-GANG XUE, Shenzhen City (CN)

(72) Inventors: ZHAO-YONG LI, Shenzhen City (CN); LIAN-GANG XUE, Shenzhen City (CN)

(21) Appl. No.: 13/659,962

(22) Filed: Oct. 25, 2012

(30) Foreign Application Priority Data
Jun. 28, 2012 (CN) 2012102176818

(51) Int. Cl. B65G 57/00

(52) U.S. Cl. 414/788.1

(57) ABSTRACT

A stacking apparatus for stacking packages includes a frame, a stacking station, a first driving mechanism, and a control box. The stacking station is movably mounted to the frame, and has a first top side on which packages are arranged one at a time. The first top side is positioned on a plane. The control box controls the first driving mechanism to lower the stacking station a predetermined distance as each package stacked to make room for other packages, to enable one side of the stacked package away from the first top side to position in the plane.

### BACKGROUND

1. Technical Field

The present disclosure relates to stacking apparatuses, particularly to a stacking apparatus for stacking packages.

2. Description of Related Art

Packages of goods meant for shipment or storage are often manually stacked which is labor intensive and thus expensive in terms of both money and time.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a stacking apparatus.

FIG. 2 is similar to FIG. 1 but the apparatus is viewed from another angle.

FIG. 3 is an inverted isometric view of the stacking apparatus in FIG. 1.

### DETAILED DESCRIPTION

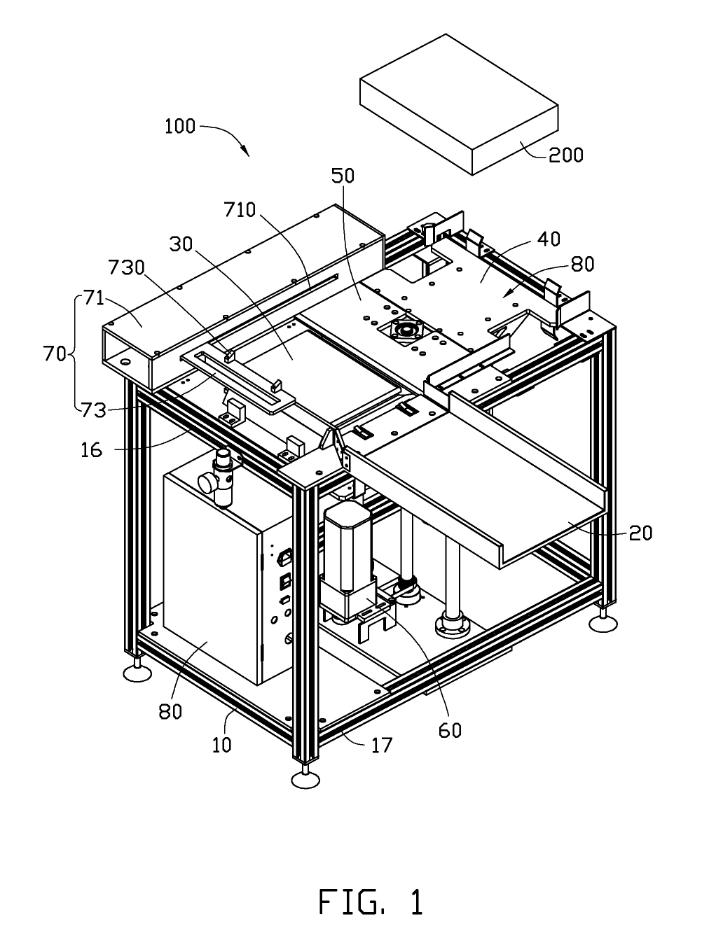

Referring to FIG. 1, a stacking apparatus 100 is shown in accordance with an embodiment. The stacking apparatus 100 is capable of stacking packages 200, such as cardboard boxes and other containers. The stacking apparatus 100 includes a frame 10, a guiding member 20, a weighing mechanism 30, a stacking station 40, a connecting portion 50, a first driving mechanism 60, a second driving mechanism 70, and a control box 80.

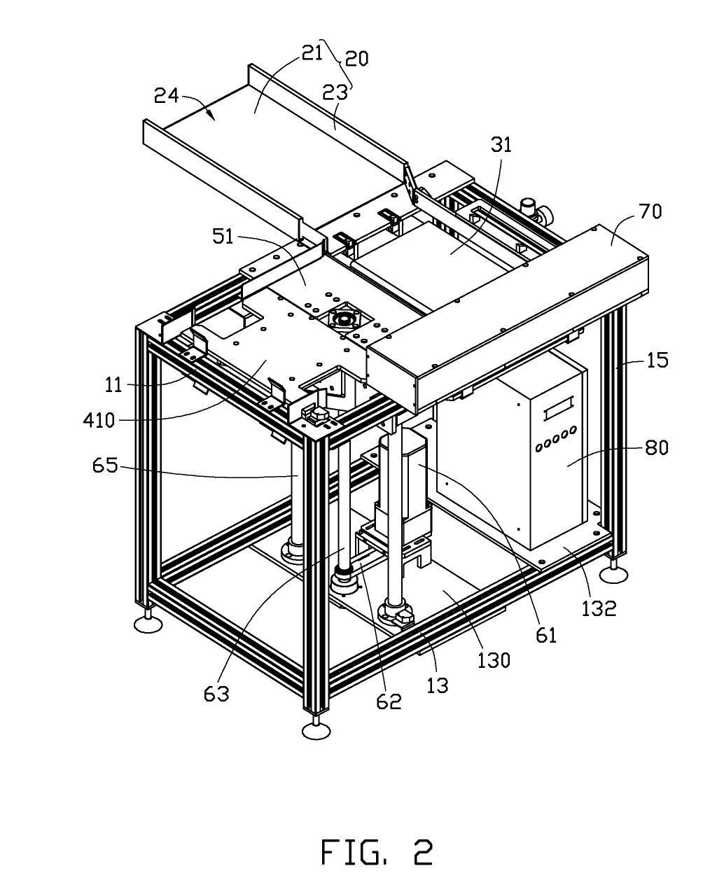

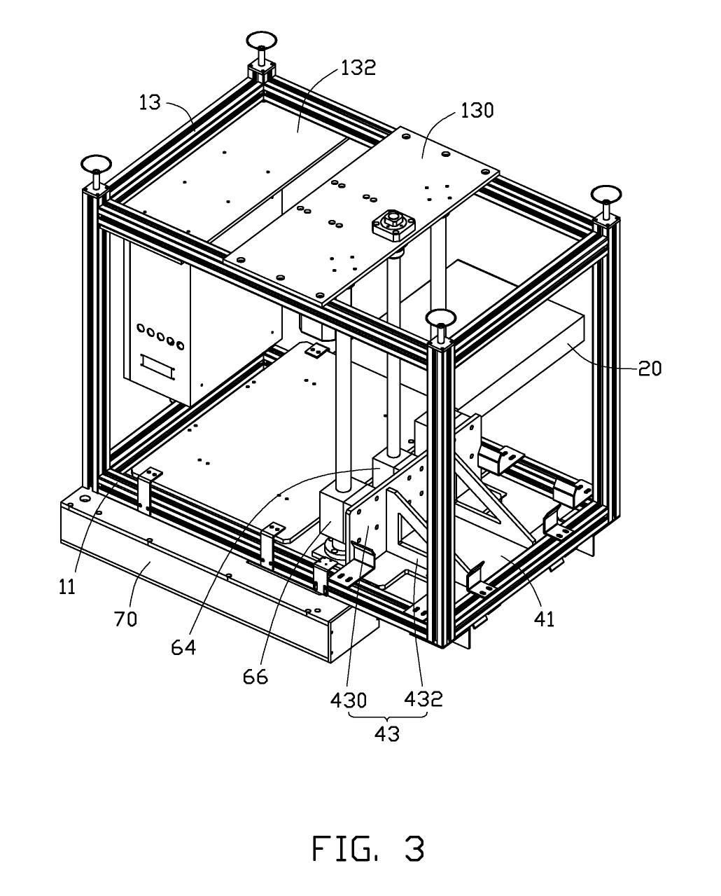

Referring also to FIGS. 2 and 3, the frame 10 includes four first beams 16, four second beams 17, and four posts 15. Each first beam 16 is connected between each two posts 15 to form a top portion 11, which is a rectangular frame positioned at one end of the posts 15. Each second beam 17 is connected between each two posts 15 to form a bottom portion 13, which is a rectangular frame adjacent to the other end of the posts 15 and parallel to the top portion 11. The posts 15 support the top portion 11 and the bottom portion 13. The bottom portion 13 supports a first supporting board 130 and a second supporting board 132. The first supporting board 130 and the second supporting board 132 are spaced from each other.

The weight mechanism 30, the stacking station 40, and the connecting portion 50 are positioned side by side on the top portion 11. The weighing mechanism 30 and the stacking station 40 are positioned at opposite ends of the top portion 11. The connecting portion 50 is connected between the weighing mechanism 30 and the stacking station 40. In original state, top sides of the weighing mechanism 30, the stacking station 40 and the connecting portion 50 are located on a same plane 80.

The weighing mechanism 30 is capable of weighing the packages 200, to detect whether the package 200 contains the proper amount of goods.

The stacking station 40 provides a platform for stacking the packages 200. The stacking station 40 is capable of perpendicularly moving with respect to the top portion 30. The stacking station 40 includes a loading board 41, and a securing structure 43 for securing and supporting the loading board 41. In an original state, the top side 410 of the loading board 41 is flat and positioned level with the plane 80. The securing structure 43 includes a securing board 430 and two triangular holders 432. The securing board 430 is perpendicular fixed on a bottom surface of the loading board 41 opposite to the top side 410 of the loading board 41. The holders 432 are perpendicularly secured to the securing board 430 and the loading board 41, are spaced apart, and parallel to each other. Each holder 432 includes two edges forming a right angle, one of the edges is connected to the loading board 41, the other edge of the holder 432 is connected to the securing board 430.

The top side 51 of the connecting portion 50 is flat, such that the connecting portion 50 provides a channel for the package 20 to move from the weighing mechanism 30 to the stacking station 40.

The first driving mechanism 60 is mounted to the first supporting board 130 and the securing board 430 for driving the stacking station 40 to move. The first driving mechanism 60 includes a motor, a belt 62, a screw shaft 63, a driving block 64, two guiding shafts 65, and two driven blocks 66. The screw shaft 63 is rotatably connected to the first supporting board 130, and the screw shaft 63 extends from the supporting board 130 to the top portion 11. The belt 62 is coupled between the motor 61 and the screw shaft 63 to transfer rotation to the screw shaft 63. One end of each guiding shaft 65 is secured to the first supporting board 130, and the other end of each guiding shaft 65 is secured to the connecting portion 50. The driving block 64 and the driven blocks 66 are secured to the securing board 430, and the driving block 64 is sleeved on the screw shaft 63 and engaged with the screw shaft 63. The driven blocks 66 are movably sleeved on the guiding shafts 65. As a result, when the motor 61 operates, the screw shaft 63 rotates to drive the driving block 64 to move with respect to the screw shaft 63, and the stacking station 40 and the sliding blocks 66 are driven to move with respect to the top portion 11. Therefore, the stacking station 40 is capable of moving up and down for stacking of the packages 200 when the motor 61 operates.

The guiding member 20 and the second driving mechanism 70 are mounted to the top portion 11, and positioned on opposite ends of the weighing mechanism 30. The guiding member 20 is adjacent to the weighing mechanism 30 and extends out of the top portion 11. The guiding member 20 includes a bottom side 21, two side boards 23 perpendicularly extending from the bottom side 21, and a sliding channel 24 forming by the bottom side 21 and the side boards 23. The bottom side 21 is coplanar with the plane 80. The sliding channel 24 enables the package 200 to slide to a top side 31 of the weighing mechanism 30.

The second driving mechanism 70 includes a main body 71, and a pulling arm 73 connected to the main body 71. The main body 71 is secured to one side of the top portion 11 away from the guiding member 20. The main body 71 includes a cylinder (not shown). The main body 71 defines a guiding slot 710. The pulling arm 73 is connected to the cylinder via the guiding slot 710, and extends towards the middle of the weighing mechanism 30. The pulling arm 73 is driven by the cylinder to move along the guiding slot 710 from one end to the other end of the guiding slot 710. Two tabs 730 protrude from one side of the arm 73. When the pulling arm 73 is positioned at one end, the tabs 730 are positioned at one side of the weighing mechanism 30 away from the connecting portion 50. When the pulling arm 73 is positioned at the other end of the guiding slot 710, the tabs 730 are positioned on one side of the stacking station 40 adjacent to the connecting portion 50.

The control box 80 is secured to the second supporting board 132. The control box 80 is capable of controlling the weighing mechanism 30, the first driving mechanism 60, and the second driving mechanism 70 as described below.

First, one of the packages 200 is slid into the weight mechanism 30 by an external force, then a weight is obtained and the arm 73 contacts the package 200. Second, the control box 80 controls the second driving mechanism 70 to drive the arm 73 from one end to the other end of the guiding slot 710, such that, the package 200 is driven to move from the weight mechanism 30 to the stacking station 40. Third, when the package 200 is positioned on the stacking station 40, the control box 80 controls the second driving mechanism 70 to drive the arm 73 to move back, and controls the first driving mechanism 60 to lower the stacking station 40 by a distance equal to the height of the package 200, so that another package 200 can be slide onto to the top of the lowered package 200. The process described above is repeated until a predetermined number of packages 200 are arranged in a stack. Fourth, once the packages 200 are stacked, the control box 80 controls the stacking station to move back to a position that allows for a next handling stage of the stacked packages 200, such as for loading onto a transport.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A stacking apparatus for stacking packages, the stacking apparatus comprising:
a frame;
a stacking station movably mounted to the frame, and having a first top side on which packages are arranged one at a time, the first top side positioned in a plane; a first driving mechanism; and
a control box controlling the first driving mechanism to lower the stacking station a predetermined distance, to enable one side of the stacked packages away from the first top side to position in the plane.

2. The stacking apparatus of claim 1, further comprising a weighing mechanism, and a second driving mechanism, the weighing mechanism being mounted to the frame and having a second top side positioned on the plane, the package being placed on the second top side to be weighed by the weighing mechanism, the control box controlling the second driving mechanism to drive the package to slide into the stacking station when the package has been weighed.

3. The stacking apparatus of claim 2, wherein the second driving mechanism comprises a main body, and a pulling arm; the main body is mounted to the frame; the pulling arm is driven by the main body to move the package from the weighing mechanism to the stacking station.

4. The stacking apparatus of claim 2, further comprising a guiding member, the guiding member defining a sliding channel, the package being capable of sliding into the weight mechanism via the sliding channel.

5. The stacking apparatus of claim 2, further comprising a connecting portion connected between the weighing mechanism and the stacking station, the connecting portion having a third top side positioned on the plane.

6. The stacking apparatus of claim 1, wherein the first driving mechanism comprises a motor, a screw shaft, and a driving block; the screw shaft is mounted to the frame and perpendicular to the plane; the driving block is engaged with the screw shaft and connected to the stacking station; the motor drives the screw shaft to rotate; the driving block is driven by the screw shaft to move, as to enable the stacking station to move.

7. The stacking apparatus of claim 1, wherein the stacking station is driven by the first driving mechanism to move to a terminal position, a number of packages are capable of being stacked on the stacking station.

8. The stacking apparatus of claim 7, wherein when the stacking station is positioned on the terminal position, the control box controls the stacking station to move into the plane.

9. The stacking apparatus of claim 7, wherein when the stacking station is positioned on the terminal position, one side of the package away from the stacking station is positioned in the plane.

10. A stacking apparatus for stacking packages, the stacking package apparatus comprising:
a frame;
a guiding member mounted to the frame to enable packages to slide into the frame;
a stacking station movably mounted to the frame to enable the packages to be stacked; and
a first driving mechanism to move the packages to the stacking station

11. The stacking apparatus of claim 10, wherein the guiding member defines a sliding channel, the package is capable of sliding into frame via the sliding channel.

12. The stacking apparatus of claim 11, further comprising a weighing mechanism, and a second driving mechanism, the weighing mechanism being mounted to the frame and having, the package being placed on and being weighed by the weighing mechanism, the control box controlling the second driving mechanism to drive the packages to slide to the stacking station when the packages are weighed.

13. The stacking apparatus of claim 12, wherein the first driving mechanism comprises a main body, and a pulling arm; the main body is mounted to the frame; the pulling arm is driven by the main body to move the package from the weighing mechanism to the stacking station.

14. The stacking apparatus of claim 10, further comprising a second driving mechanism comprises a motor, a screw shaft, and a driving block; the screw shaft being mounted to the frame and perpendicular to the plane; the driving block being engaged with the screw shaft and connected to the stacking station; the motor driving the screw shaft to rotate, the driving block being driven by the screw shaft to move, as to enable the stacking station to move.

15. A stacking apparatus for stacking packages, the stacking package apparatus comprising:
a frame;
a weighing mechanism mounted to the frame to weigh packages;
a stacking station movably mounted to the frame to enable the weighed packages to be stacked; and
a first driving mechanism to move the packages from the weighing mechanism to the stacking station.

16. The stacking apparatus of claim 15, further comprising a guiding member defines a sliding channel, the packages are capable of sliding from the outer of the frame into the weighing mechanism via the sliding channel.

17. The stacking apparatus of claim 15, wherein the first driving mechanism comprises a main body, and a pulling arm; the main body is mounted to the frame; the pulling arm is driven by the main body to move the package from the weighing mechanism to the stacking station.

18. The stacking apparatus of claim 15, further comprising a second driving mechanism comprises a motor, a screw shaft, and a driving block; the screw shaft being mounted to the frame and perpendicular to the plane; the driving block being engaged with the screw shaft and connected to the stacking station; the motor driving the screw shaft to rotate, the driving block being driven by the screw shaft to move, as to enable the stacking station to move.
